(19) United States
(12) Patent Application Publication
(10) Pub. No.: US 2026/0251283 A1
(43) Pub. Date: Aug. 27, 2026

(54) Cluster Linear Cup Optics

(71) Applicant: SIGNIFY HOLDING B.V., EINDHOVEN (NL)

(72) Inventors: RYAN GATES, LANGLEY (CA); KWONG HUNG MAN, LANGLEY (CA)

(21) Appl. No.: 18/726,167

(22) PCT Filed: Dec. 21, 2022
(86) PCT No.: PCT/EP2022/087160

§ 371 Date: Jul. 2, 2024

Related U.S. Application Data
(60) Provisional application No. 63/296,948, filed on Jan. 6, 2022.

(30) Foreign Application Priority Data
Jan. 18, 2022 (EP) 22151926.7

(51) Int. Cl. F21V 5/00; F21S 4/28; F21V 5/04; F21V 7/00

(52) U.S. Cl. CPC F21V 5/007; F21S 4/28; F21V 5/008; F21V 5/048; F21V 7/0091

(57) ABSTRACT

An illumination module and illumination systems incorporating such modules are provided. The illumination systems include a housing body that secures one or more arrays of illumination modules, with each array of illumination modules comprising one or more individual illumination modules. Specifically, each illumination module can include: a retaining cup having a first end, a second end, and a sidewall extending from the first end to the second end, where the second end of the retaining cup defines an exit aperture of the illumination module; a light source disposed on a portion of a first surface of a light source board, wherein the portion of the first surface of the light source board covers the first end of the retaining cup; and a total internal reflection (TIR) optical device having an optical film, the TIR optical device being disposed within the retaining cup and abutting the light source.

### FIELD OF THE DISCLOSURE

The present disclosure is directed generally to illumination systems, specifically to illumination systems with configurable beam arrangements.

### BACKGROUND

Despite the advances in LED lighting, many consumers continue to find the visible LED lens to be bright, glaring, or otherwise objectionable. Current approaches to solving such issues typically involve either the use of very small total internal reflection (TIR) lenses, which lead to an intense and uncomfortable visible light beam with shadows on the workplane, or the use of a large, single optical device that is expensive and round in shape. Accordingly, it would be desirable to provide illumination systems and illumination modules having a large emitting surface for visual comfort and a very low unified glare rating while maintaining optical precision for over many light beam patterns.

### SUMMARY OF THE DISCLOSURE

According to a first embodiment of the present disclosure, an illumination module is described. The illumination module may comprise: a retaining cup having a first end, a second end, and a sidewall extending from the first end to the second end, wherein the second end of the retaining cup defines an exit aperture of the illumination module; a light source disposed on a portion of a light source board, wherein the portion of the light source board covers the first end of the retaining cup; and a total internal reflection (TIR) optical device having an optical film, the TIR optical device being disposed within the retaining cup and abutting the light source.

In one aspect, the light source of the illumination module may comprise a light emitting diode (LED).

In one aspect, the light source of the illumination module may comprise two or more LEDs.

In one aspect, the TIR optical device of the illumination module may comprise a TIR lens.

In one aspect, the TIR optical device of the illumination module may comprise an arrangement of at least two TIR lenses.

In one aspect, the optical film of the TIR optical device may be disposed directly on the TIR optical device.

In one aspect, the optical film of the TIR optical device may be disposed directly on the arrangement of at least two TIR lenses.

In one aspect, the TIR optical device of the illumination module may be configured to receive a light beam from the light source and the optical film of the TIR optical device may be configured to create one or more of the following beam patterns from the light beam: a graze pattern; a narrow pattern; a medium pattern; a stack pattern; a batwing pattern; and an asymmetric pattern.

According to a second embodiment of the present disclosure, an illumination system is described. The illumination system may comprise: a housing body securing one or more arrays of illumination modules, each array of illumination modules comprising one or more illumination modules. Each illumination module of the array of illumination modules may comprise: a retaining cup having a first end, a second end, and a sidewall extending from the first end to the second end, wherein the second end of the retaining cup defines an exit aperture of the illumination module; a light source disposed on a portion of a first surface of a light source board, wherein the portion of the first surface of the light source board covers the first end of the retaining cup; and a total internal reflection (TIR) optical device having an optical film, the TIR optical device being disposed within the retaining cup and abutting the light source.

In one aspect, the illumination system may further comprise: a light board bracket secured to a second surface of the light source board; a housing cover disposed at the second end of one or more retaining cups of the one or more arrays of illumination modules; and one or more side cover panels affixed to an end of the housing body.

In one aspect, each array of illumination modules may comprise between two and six illumination modules.

In one aspect, the one or more arrays of illumination modules may comprise between two and six arrays of illumination modules.

In one aspect, the light source of each illumination module may comprise a light emitting diode (LED).

In one aspect, the light source of each illumination module may comprise two or more LEDs.

In one aspect, the optical film of each illumination module may be disposed directly on the TIR optical device.

In one aspect, the TIR optical device of each illumination module may comprise a TIR lens.

In one aspect, the TIR optical device of each illumination module may comprise an arrangement of at least two TIR lenses.

In one aspect, the optical film of each illumination module may be disposed directly on the arrangement of at least two TIR lenses.

In one aspect, the arrangement of at least two TIR lenses may comprise an arrangement of at least four TIR lenses.

In one aspect, the TIR optical device of each illumination module may be configured to receive a light beam from the light source and the optical film of each TIR optical device may be configured to create one or more of the following beam patterns from the light beam: a graze pattern; a narrow pattern; a medium pattern; a stack pattern; a batwing pattern; and an asymmetric pattern.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a front perspective exploded view of an illumination system according to the present disclosure.

FIG. 2 is a first perspective view of a retaining cup of an individual illumination module according to certain aspects of the present disclosure.

FIG. 3 is a second perspective view of a retaining cup of an individual illumination module according to further aspects of the present disclosure.

FIG. 4 is a top view of a portion of a light source board without a TIR optical device of an illumination system according to the present disclosure.

FIG. 5 is a top view of a portion of a light source board with a TIR optical device of an illumination system according to the present disclosure.

FIG. 6 is a perspective view of a portion of an array of illumination modules according to certain aspects of the present disclosure.

FIGS. 7A through 7F are light beam patterns that may be created using the illumination modules according to the present disclosure.

FIG. 8 is a partial perspective view of a partially assembled illumination system according to the present disclosure.

### DETAILED DESCRIPTION OF EMBODIMENTS

The present disclosure provides an illumination modules and illumination systems comprises such modules that are configured to create one or more patterns of light. The illumination modules described herein are scalable, have a large emitting surface for visual comfort, and have a very low unified glare rating, all while maintaining precise optical control.

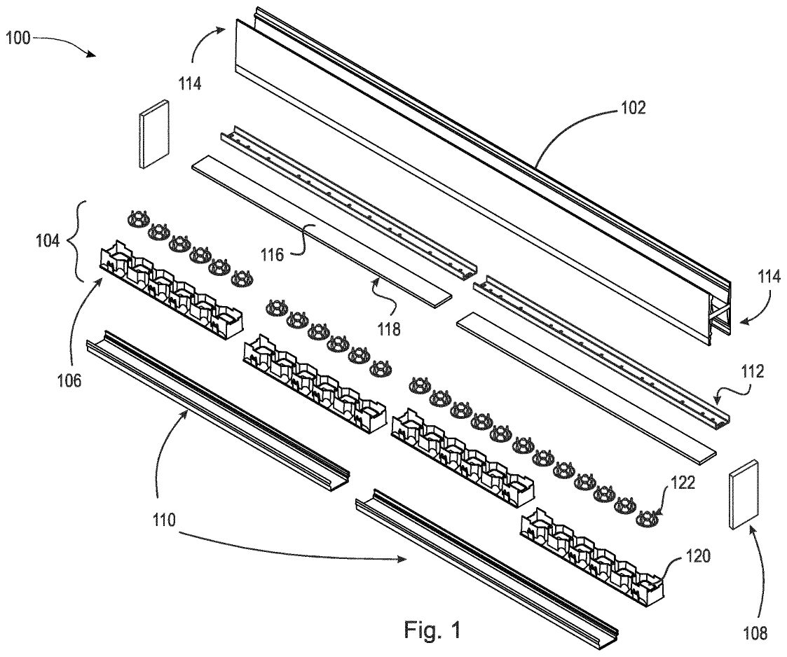

Turning to FIG. 1, one embodiment of an illumination system 100 is illustrated according to the present disclosure in an exploded perspective view. The illumination system 100 comprises a housing body 102 securing one or more arrays 104 of illumination modules 106. In some embodiments, the housing body 102 is an extruded component comprising a light-weight metal or alloy, such as aluminum. In other embodiments, the housing body 102 can be an extruded component comprising a heavier metal or alloy, such as stainless steel.

The illumination system 100 can further include one or more cover panels 108, one or more housing covers 110, and one or more light board brackets 112. In specific embodiments, the one or more cover panels 108 are secured at a corresponding end 114 of the housing body to provide the illumination system 100 with an appealing outer surface and to prevent movement of the array 104 of illumination modules 106 within the housing body 102. In further embodiments, the one or more housing covers 110 are disposed below the illumination modules 106 (i.e., along the direction of the generated light pattern) and includes a securing feature, such as the flexible clips, that engage with the housing body 102 to provide an appealing bottom surface and to prevent movement of the array 104 of illumination modules 106 within the housing body 102. In still further embodiments, the one or more light board brackets 112 are disposed at a back surface 116 (i.e., a second surface 116) of the light source boards 118 of the array 104 of illumination modules 106 and are configured to further secure the array of illumination modules 106 within the housing body 102.

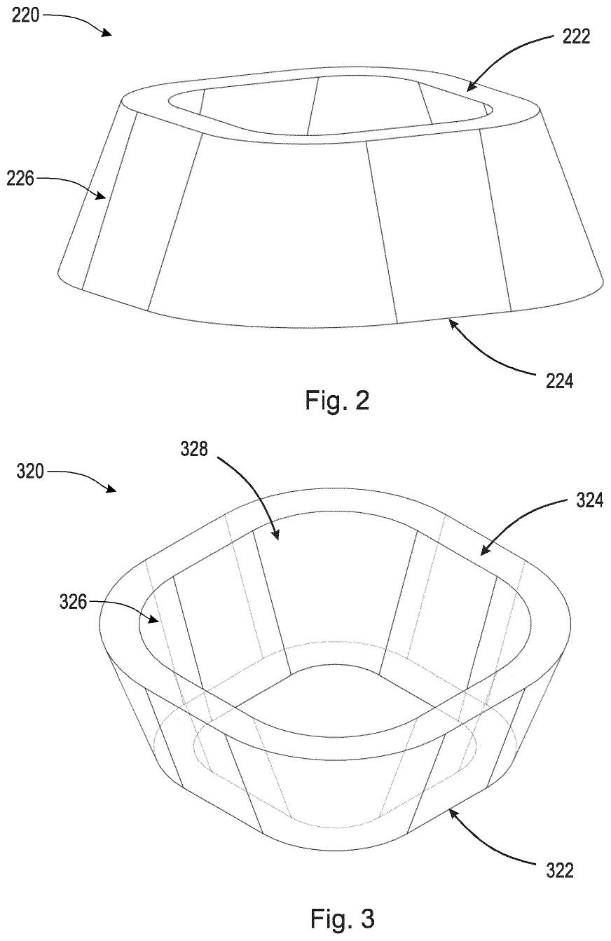

In accordance with certain aspects of the present disclosure, each illumination module 106 of the array 104 of illumination modules 106 can comprise: a retaining cup 120; a light source disposed on a portion of a first surface of a light source board 118; and a total internal reflection (TIR) optical device 122 having an optical film. As shown in FIGS. 2 and 3, each retaining cup 120, 220, 320 can include a first end 222, 322, a second end 224, 324, and a sidewall(s) 226, 326 extending from the first end 222, 322 to the second end 224, 324, where the second end 224, 324 of the retaining cup 120, 220, 320 defines an exit aperture 328 of the illumination module 106. In particular embodiments, the exit aperture 328 is the opening in the end 224, 324 of the retaining cup 120, 220, 320 from which a light beam pattern generated by the illumination module 106 is emitted. In particular embodiments, the sidewall(s) 226, 326 extending from the first end to the second end may be angled such that the second end 224, 324 is wider than the first end 222, 322. Although not limited to a particular geometry, the retaining cup 120, 220, 320 illustrated have a square cross-section with filleted corners, which creates the appearance of a square inner cup 326.

Returning to FIG. 1, each illumination module 106 of the array 104 of illumination modules 106 can include a light source disposed on a portion of a first surface of a light source board 118. In particular embodiments, the light source board 118 may be shared between one or more arrays 104 of illumination modules 106, and each array 104 of illumination modules 106 can include one or more illumination modules 106. For example, as shown in FIG. 1, the illumination system 100 includes four arrays 104 of illumination modules 106, each array 104 comprising six individual illumination modules 106, which are shared between two light source boards 118. Each of the light source boards 118 are configured to cover the first end 222, 322 of the corresponding retaining cups 120, 220, 320 such that the light sources of each illumination module 106 are positioned over the exit apertures 328 of the corresponding illumination module 106.

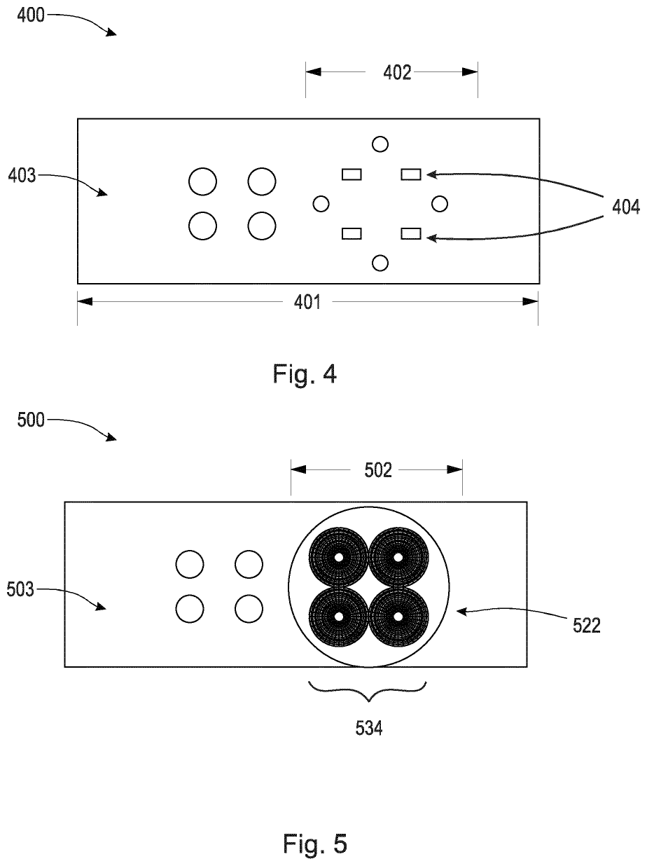

With reference to FIG. 4, one section 401 of a light source board 400 is illustrated according to certain aspects of the present disclosure. As shown, the section 401 includes a portion 402 of a first surface 403 of the light source board 400 where a cluster of light sources 404 are disposed. According to the present disclosure, each portion 402 of the first surface 403 of the light board 400 is configured to cover the first end 222, 322 of a corresponding retaining cup 120, 220, 320 such that the light source 404 of each illumination module 106 is adjacent to the first end 222, 322 of the retaining cup 120, 220, 320.

According to certain embodiments, the light source 404 can include a light emitting diode (LED) disposed within the first portion 402 of the first surface 403 of the light source board 400. In further embodiments, the light source 404 includes a cluster of two or more LEDs disposed within the first portion 402 of the first surface 403 of the light source board 400. One or more of the LEDs can be, for example, an ultra-lower power LED, a low power LED, a mid-power LED, and/or a high-power LED.

Returning to FIG. 1, each illumination module 106 of the array 104 of illumination modules can further include a TIR optical device 122. In other words, the array 104 of illumination modules 106 can include a plurality of TIR optical devices 122, each TIR optical device 122 corresponding to one light source 404 (or cluster of light sources 404) and one retaining cup 120, 220, 320. The TIR optical devices 122 or portions thereof can comprise a polymer such as a polymethylmethacrylate or a polycarbonate.

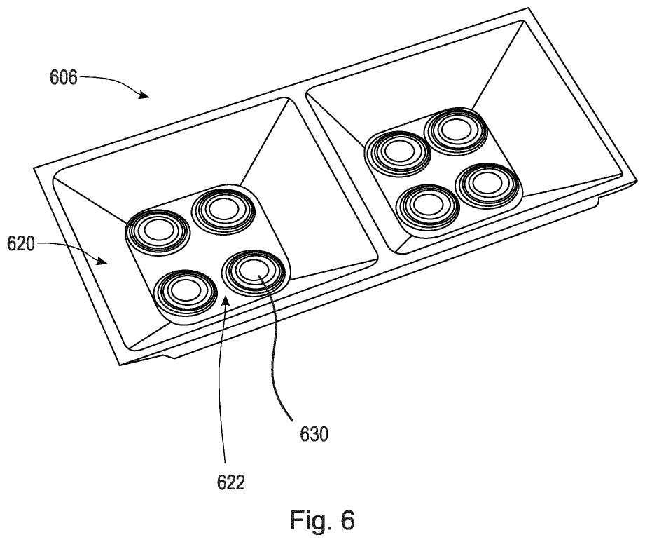

According to the present disclosure, each of the TIR optical devices 122 can be disposed within the corresponding retaining cup 120, 220, 320 and abutting the corresponding light source 404. For example, as illustrated in FIG. 5, a TIR optical device 522 is secured to a portion 502 of the first surface a light source board where a light source is disposed such that the TIR optical device is adjacent to and abutting the light source. The TIR optical device can be secured to a portion 502 of the first surface 503 of the light source board 500 such that each TIR optical device 522 sits within a corresponding retaining cup 120, 220, 320. As illustrated in FIG. 6, a perspective view of two illumination modules 606 are shown from below where each illumination module 606 includes a retaining cup 620 and a TIR optical device 622 that is disposed within the corresponding retaining cup 620.

According to the present disclosure, each of the TIR optical devices 122, 522, 622 can be configured to receive a light beam from the corresponding light source 404. In particular embodiments, the TIR optical device 122, 522, 622 can include a TIR lens 630 that collimates light from the light source 404 towards the exit aperture 328 of the illumination module 106. In further embodiments, the TIR optical device 122, 522, 622 includes an arrangement 534 of at least two TIR lenses 630, that are integrated or clustered into a signal optic, that collimate light from the light source 404 towards the exit aperture 328 of the illumination module 106. For example, in specific embodiments, the light source 404 can include four LEDs and the TIR optical device 122, 522, 622 can include a cluster of four TIR lenses 630 arranged in a 2-by-2 pattern 534 where each TIR lens 630 of the TIR optical device 122, 522, 622 sits adjacent to a corresponding LED of the light source 404.

In still further embodiments, each of the TIR optical devices 122, 522, 622 of each illumination module 106 can include an optical film, such as a MesoOptic® film. The optical film may be utilized create controlled patterns of light by redirecting light into a desired light distribution. In other words, a light beam from a light source 404 of an illumination module 106 can be passed through a TIR lens 630 of a TIR optical device 122, 522, 622 thereby generating a tight/narrow light beam (i.e., a 15° by 15° beam of light), which then passes through a corresponding optical film disposed directly on a surface of the TIR optical device 122, 522, 622 to generate and precisely control one or more light beam patterns. In particular embodiments, each TIR optical device 122, 522, 622 having an optical film is configured to create one or more of the following beam patterns from the light beam: a graze pattern; a narrow pattern; a medium pattern; a stack pattern; a batwing pattern; an asymmetric pattern; and combinations thereof. However, other light beam patterns are contemplated.

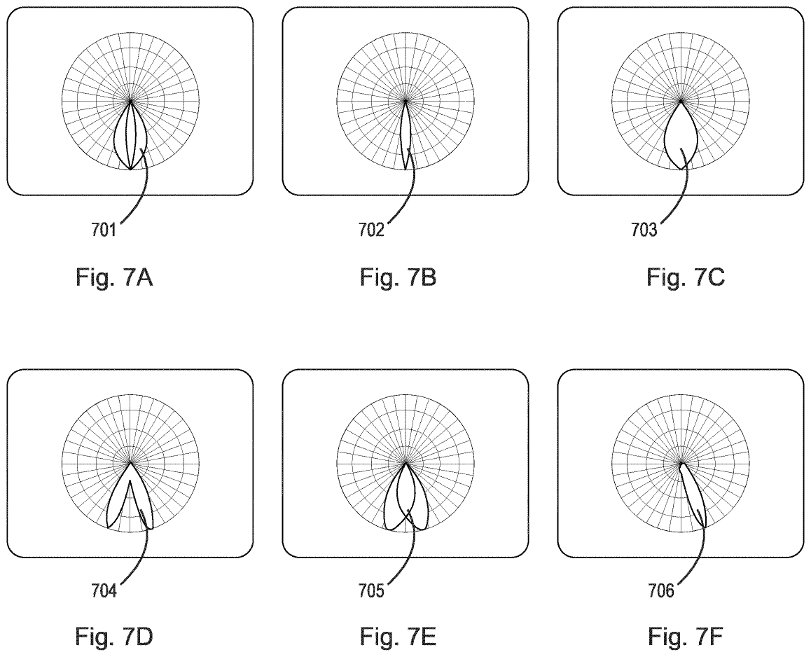

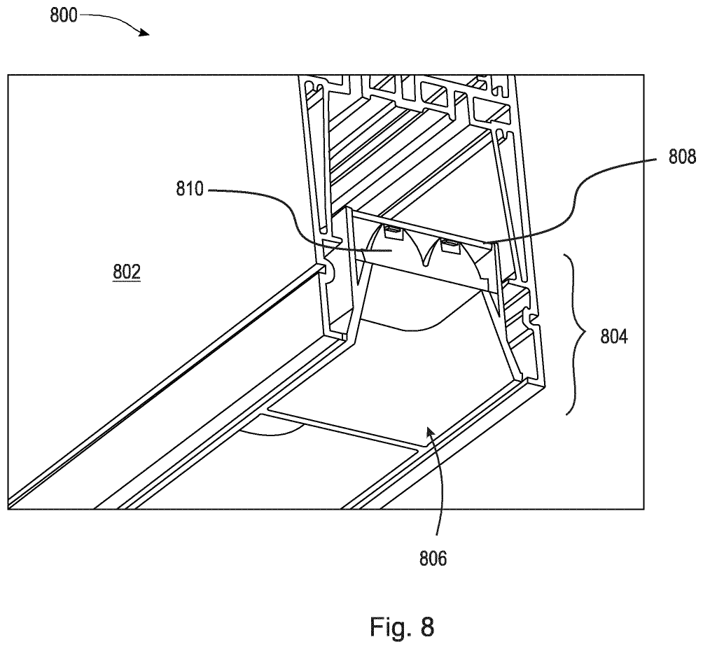

With reference to FIGS. 7A-7F, each of these beam patterns are illustrated, including a graze pattern 701 shown in FIG. 7A, a narrow pattern 702 shown in FIG. 7B, a medium pattern 703 shown in FIG. 7C, a stack pattern 704 shown in FIG. 7D, a batwing pattern 705 shown in FIG. 7E, and an asymmetric pattern 7060 shown in FIG. 7F. In accordance with various aspects of the present disclosure, the graze pattern 701 can have the approximate dimensions 16.6° by 55°, the narrow pattern 702 can have the approximate dimensions 23.7° by 24.4°, the medium pattern 703 can have the approximate dimensions 42.6° by 45.1°, the stack pattern 704 can have the approximate dimensions 60.7° by 72.2°, the batwing pattern 705 can have the approximate dimensions 58.1° by 36.1°, and the asymmetric pattern can have the approximate dimension of 17.5°.

With reference to FIG. 8, a partially assembled illumination system 800 is illustrated from a perspective view in accordance with various aspects of the present disclosure. As discussed herein, the illumination system 800 comprises a housing body 802 securing one or more arrays of illumination modules 804, each array of illumination modules 804 comprising one or more illumination modules 804. Each illumination module 804 of the array of illumination modules 804 can include: (i) a retaining cup having a first end, a second end, and a sidewall extending from the first end to the second end, where the second end of the retaining cup defines an exit aperture 806 of the illumination module 804; (ii) a light source (not visible) disposed on a portion of a first surface of a light source board 808, where the portion of the first surface of the light source board 808 covers the first end of the retaining cup; and (iii) a total internal reflection (TIR) optical device 810 having an optical film (not visible), where the TIR optical device 810 is disposed at or within the retaining cup and abutting the light source.

By providing such illumination systems and illumination modules, a large light-emitting surface is for visual comfort is achievable with a very low unified glare rating while maintaining optical precision for over many light beam patterns. Additionally, the different precise beam patterns can be generated using the disclosed illumination systems and illumination modules without the need for altering the shape or size of the retaining cups. Finally, by having the light source (e.g., the LEDs) spaced wide rather than clustered under a single TIR lens, the disclosed illumination systems and modules virtually eliminate shadows from having discrete points and reduces the color-over-angle effects from certain LED chips.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An illumination module comprising:
a retaining cup having a first end, a second end, and a sidewall extending from the first end to the second end, wherein the second end of the retaining cup defines an exit aperture of the illumination module;
a plurality of light sources disposed on a portion of a light source board, wherein the portion of the light source board covers the first end of the retaining cup; and
a total internal reflection optical device having an optical film, wherein the TIR optical device includes a plurality of integrated TIR lenes, the TIR optical device being disposed within the retaining cup and abutting the light source, wherein each TIR lenes corresponds to a respective light source(s).

2. The illumination module of claim 1, wherein the light source comprises a light emitting diode.

3. The illumination module of claim 2, wherein the light source comprises two or more LEDs.

4. The illumination module of claim 1, wherein the optical film is disposed directly on the TIR optical device.

5. The illumination module of claim 1, wherein the TIR optical device comprises a TIR lens.

6. The illumination module of claim 1, wherein the TIR optical device comprises an arrangement of at least two TIR lenses.

7. The illumination module of claim 6, wherein the optical film is disposed directly on the arrangement of at least two TIR lenses.

8. The illumination module of claim 1, wherein the TIR optical device is configured to receive a light beam from the light source and the optical film is configured to create one or more of the following beam patterns from the light beam: a graze pattern; a narrow pattern; a medium pattern; a stack pattern; a batwing pattern; and an asymmetric pattern.
